(19) United States
(12) Patent Application Publication
(10) Pub. No.: US 2026/0161612 A1
(43) Pub. Date: Jun. 11, 2026

(54) UNSTRUCTURED ASSET CONVERGENCE, MONITORING, AND FORECASTING

(71) Applicant: Moody’s Analytics, Inc., New York, NY (US)

(72) Inventors: Javier Tarragona, Barcelona (ES); Francisco Sobrino, Barcelona (ES); Daniel Spruenker, Berlin, DE (US); Robert Cox, Charlotte, NC (US); Tim Elsner, Stamford, CT (US); Luis Amador, White Plains, NY (US)

(73) Assignee: Moody’s Analytics, Inc., New York, NY (US)

(21) Appl. No.: 18/975,793

(22) Filed: Dec. 10, 2024

(51) Int. Cl. G06F 16/21; G06F 16/2455

(52) U.S. Cl. CPC G06F 16/211; G06F 16/2455

(57) ABSTRACT

Disclosed are systems, apparatuses, processes, and computer-readable media for unstructured asset convergence, monitoring, and forecasting. For example, a disclosed method includes receiving a collection of unstructured documents; generating structured data based on the collection of unstructured documents; identifying a property identifier of a first asset within the structured data, the property identifier being associated with a single physical structure; in response to receiving an unstructured notification, identifying an entity associated with the unstructured notification and a second asset corresponding to the entity; determining, by a machine learning model, that the first asset will be affected based on the unstructured notification based on at least one of the entity, a proximity of the first asset to the second asset; and providing a notification regarding the first asset and potential changes to the first asset based on the entity or the second asset.

### TECHNICAL FIELD

The present disclosure relates to machine learning and, in particular, unstructured asset convergence, monitoring, and forecasting.

### BACKGROUND

Machine learning (ML) models are computational systems designed to perform specific tasks by learning from data rather than being explicitly programmed. These models are trained on large datasets to recognize patterns, make predictions, or classify data. Raw data, often gathered from various sources and is then cleaned and transformed into a format suitable for training. Preprocessing step involves tasks such as removing outliers, normalizing features, handling missing values, and possibly augmenting the data to increase its diversity. Training involves feeding the preprocessed data into an ML model in batches and optimizing results by learning to map inputs to the desired outputs by iteratively adjusting its parameters. This is done using an optimization algorithm, such as stochastic gradient descent. The error is quantified using a loss function, which the algorithm seeks to minimize. The process is repeated over many iterations, or epochs, to progressively reduce the loss and improve the model's performance.

An ML model is only as good as the data it is trained on and the system used to train it. High-quality, diverse, and representative data is crucial because the model learns patterns and makes predictions based on this data. If the data is biased, incomplete, or noisy, the model's predictions will reflect these flaws, leading to poor performance or even harmful outcomes. An efficient and well-optimized training system ensures that the model can learn effectively from the data, utilizing the right algorithms, hyperparameters, and resources. Without good data and a robust training system, even the most sophisticated model architecture will fail to deliver accurate, reliable, and fair results.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for unstructured asset convergence, monitoring, and forecasting with machine learning. According to aspects described herein, devices using the systems and techniques can model and forecast asset changes in real-time. An example method includes receiving a collection of unstructured documents; generating structured data based on the collection of unstructured documents; identifying a property identifier of a first asset within the structured data, the property identifier being associated with a single physical structure; in response to receiving an unstructured notification, identifying an entity associated with the unstructured notification and a second asset corresponding to the entity; determining, by a machine learning model, that the first asset will be affected based on the unstructured notification based on at least one of the entity, a proximity of the first asset to the second asset; and providing a notification regarding the first asset and potential changes to the first asset based on the entity or the second asset.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 is a conceptual illustration of a model associated with a node in a multi-dimensional and its relationships to other nodes in accordance with some aspects of the disclosure;

FIG. 2 is a conceptual block diagram illustrating an asset management system for implementing various aspects of this disclosure in accordance with some aspects of the disclosure;

FIG. 3A illustrates a functional block diagram of an asset management system 300 in accordance with some aspects of the disclosure;

FIG. 3B illustrates a block diagram of a generative response engine, an ML model engine, and a featurization engine in accordance with some aspects of the disclosure;

FIG. 4 illustrates an example method for real-time analysis of assets using an ML model in accordance with some aspects of the disclosure;

FIG. 5 illustrates example notifications of a real-time asset monitoring and valuation system in accordance with some aspects of the disclosure;

FIG. 6 illustrates example identification of valuation changes of a client's assets in accordance with some aspects of the disclosure;

FIG. 7 illustrates an example prediction of valuation changes based on user input in accordance with some aspects of the disclosure;

FIG. 8 is a block diagram of an example transformer in accordance with some aspects of the disclosure; and

FIG. 9 is a diagram illustrating an example of a system for implementing certain aspects of the present technology.

### DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Most data generated is unstructured data intended for human consumption. For example, natural language text writing is unstructured and does not detail details regarding relationships that a machine needs to understand the content. By contrast, structured data is intended for machine consumption and includes JavaScript Object Notation (JSON), extensible markup language (XML), etc. Commercial real estate and other market competitors use notifications, personal connections, and sources of events to maintain a business advantage. However, it is difficult to forecast changes even if the information surfaced because there are many potential interests, from lenders to owners. The interests can include third parties. As a result, even current knowledge of events is challenging to fully comprehend because the number of dimensions associated with the relationships is massive.

Systems, apparatuses, processes (also referred to as methods), and computer-readable media (collectively referred to as “systems and techniques”) are described herein for unstructured asset convergence, monitoring, and forecasting with machine learning. For example, techniques are disclosed to converge different sources of information based on a unique property identifier that resolves different addresses and other natural language representations into an accurate representation of the property. Based on the property identifier, unstructured and structured data can be converged and relationships can be identified using procedural techniques. In some cases, machine learning models and techniques can be implemented to implemented to provide greater insights, infer additional relationships and forecast changes. For example, machine learning models can be used to convert unstructured data into structured data to align with a specific model (e.g., a property model). In addition, a generative response engine is also included and allows an asset management system using the disclosed techniques to forecast changes based on human-guided instructions and constraints. The asset management system allows insights into asset valuation to be uncovered in real-time, providing a competitive advantage. For example, the asset valuation can be a value of the asset (e.g., a price to acquire) or a cost to obtain a property interest (e.g., a lease).

The disclosed systems and techniques described herein streamline analysis of multiple layers of conventional human analysis into a processes that can be performed in real time without the delays incurred by conventional analysis. For example, conventional human-oriented implementation of these processes may take several weeks because the amount of information necessary to perform such an analysis comes from different sources. The systems and techniques described herein are unable to be performed by human processes due to the volume of information, the number of variables, and the volume or related information.

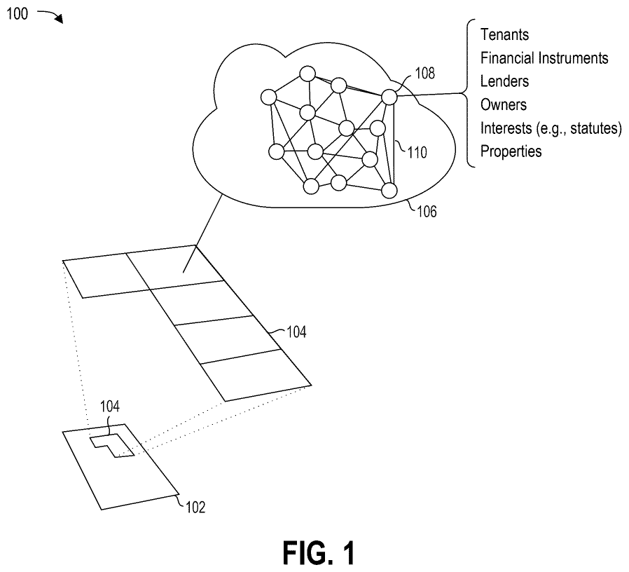

FIG. 1 is a conceptual illustration 100 of a model associated with a node in a multi-dimensional and its relationships to other nodes in accordance with some aspects of the disclosure. Modeling of real-world assets, whether tangible or intangible, is complex and cannot feasibly be captured based on conventional procedural processes that use hard rules. It is not humanly feasible to capture the relationship of a property and its downstream and indirect relationships. Approximations can be made, but simplifications to the model ensure that all of its relationships and events that do not have a direct nexus to the property cannot be foreseen. For example, downstream events associated with disputes of liens of unrelated properties could materially affect the property. As an example, reclassification of the zoning of a property or adjacent properties may affect the property's uses and/or value.

The conceptual illustration 100 is a conceptual illustration of a real property 102. The real property 102 is adjacent to other real properties (not shown) and other geographic features. In this illustrated aspect, real property 102 includes a building 104 is subdivided into a plurality of leasehold properties that are available for different types of legal arrangements (e.g., a leasehold agreement), such as leasehold property 106.

A leasehold property 106 can be modeled as a graph having many different interacting components. The leasehold property 106 can include many different types of aspects that need to be modeled, from physical properties (e.g., metes and bounds), legal properties (e.g., lease, zoning), financial properties (e.g., securitized interests, etc.), direct relationships (e.g., owners, lenders, lessor, sub-lessor), indirect relationships (e.g., proximity of interested entities, tenants, etc.), and so forth. Each of these aspects can have relationships among themselves, as well as with other properties and other direct and indirection relationships. In other words, the properties of each leasehold property 106 are complex and cannot realistically be modeled based on conventional, procedural models. The leasehold property 106 is represented as a graph having a plurality of nodes 108 and relationships between at least two nodes 108 formed by edges 110.

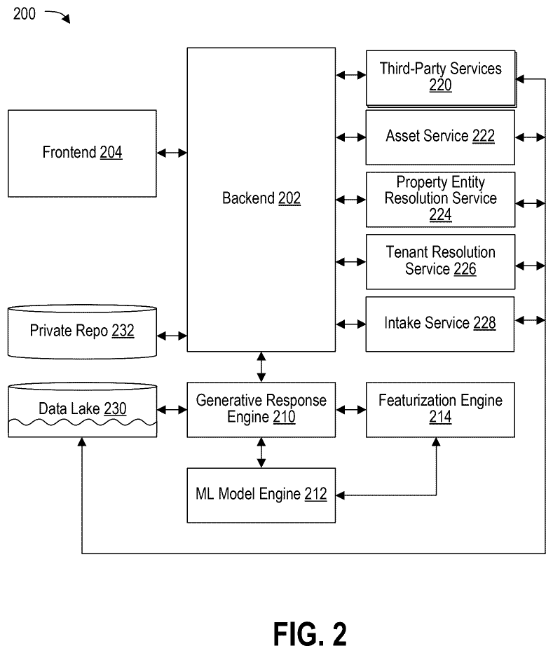

FIG. 2 is a conceptual block diagram illustrating an asset management system 200 for implementing various aspects of this disclosure in accordance with some aspects of the disclosure. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components, additional services can be included, or additional connections between different components of the system may be implemented.

The asset management system 200 includes a backend 202 (e.g., a server) and a frontend 204 (e.g., a client application). The backend 202 may serve the frontend 204 to a client (e.g., as a web application), but the frontend 204 may also be a separately distributed application (e.g., from an app store) or can also be an API. The backend 202 provides a common interface to various services to implement the asset management system 200.

In some cases, the asset management system 200 may include a generative response engine 210 and use one or more ML models to provide additional functionality. For example, the generative response engine may be configured to extract structured data from unstructured data (e.g., extract information in news article to a data structure representing a feature within the article). The generative response engine 210 includes various components to form structured output (e.g., data formatted in JavaScript Object Notation (JSON)) and unstructured output (e.g., human language text) using ML models of the ML model engine 212. For example, the generative response engine 210 includes a predictive output generation engine and output validation engine. The predictive output generation engine is configured to receive inputs from the frontend 204 that provides guidance related to a desired output. In some cases, the frontend 204 can be a graphical user interface that receives natural language inputs and provides responses from the generative response engine 210. The output validation engine is configured to apply validation data to the ML model output.

In some aspects, the generative response engine 210 is optional and can be excluded. The generative response engine 210 provides an additional layer of functionality to enhance the inferences in the identification of assets that can be compromised based on current events.

The predictive output generation engine of the generative response engine 210 analyzes the input and identifies relevant patterns and associations in the data that the generative response engine 210 has learned, and the generative response engine 210 generates a sequence of words is the most likely continuation of the input using one or more ML models in the ML model engine 212 to provide a coherent and contextually relevant answer. The predictive output generation engine of the generative response engine 210 generates responses by sampling from the probability distribution of possible words and sequences based on the patterns observed during training. In some aspects, the predictive output generation engine may generate multiple possible responses before presenting the final one. These responses are variations that the predictive output generation engine considers potentially relevant and coherent. The generative response engine 210 may also include an output validation engine to evaluate the generated responses based on certain criteria. Non-limiting examples of criteria for the output validation engine include relevance to the prompt, coherence, fluency, and adherence to specific guidelines or rules, depending on the application. The output validation engine selects the most appropriate response based on the criteria based on a response that scores highest on the set criteria, balancing factors like relevance, informativeness, and coherence.

The ML model engine 212 is configured to execute one or more operations ML operations associated with at least one ML model. Non-limiting examples of ML operations model re-configuration, model validation, and model testing. For example, in some cases, the ML model engine 212 can backpropagate based on an identified error to improve an output (e.g., fine-tuning) based on new information. In some aspects, the ML model engine 212 may execute an operation to train a machine learning model, such as adding, removing, or modifying a model parameter. Training of a machine learning model may be supervised, semi-supervised, or unsupervised. The training of a machine learning model may include multiple epochs, or iterations of application of data through an ML model process to improve inference performance. In some embodiments, different epochs may have different degrees of supervision (e.g., supervised, semi-supervised, or unsupervised). The data provided to train the model may include input data (e.g., as described above) and/or data previously output from a model (e.g., forming a recursive learning feedback). A model parameter may include one or more of a seed value, a weight, a model layer, an algorithm, a function, a connection (e.g., between other layers in the ML model), a model constraint, or any other digital component influencing the output of a model.

The ML model engine 212 may include model selector engine (not shown) and configured to select a model from among a plurality of models, such as based on input data. For example, the ML model engine 212 may include a model for extracting features for the featurization engine 214. The ML model engine 212 may also include a training subsystem configured to train or fine-tune one or more machine learning models. For example, as disclosed below, entities are rapidly evolving within the market and disambiguating the entities is a complex process. For example, new entities may be introduced, entities may be acquired, and so forth. Within entities are further assets, such as people, that may themselves be considered an entity.

The asset management system 200 may include featurization engine 214 configured to extract features from content and label the different features of the content. For example, the ML model engine 212 may include an attention mechanism to identify pertinent features in different types of content, such as text or images. The featurization engine 214 be configured to determine, select, limit, constrain, concatenate, or define features for use with different ML models.

In some aspects, the backend 202 is configured as an application to interact with multi-dimensional data and models complex relationships in the real world, changes to relationships in the real world, and provides enhanced information services in real-time. A non-limiting example of an application is commercial real estate, which has complex relationships between data, events, regulatory authorities, other entities, news, and people. An example is described with reference to the commercial real estate market and an application of the subject technology that can translate events in real-time (e.g., within seconds) to forecast market events. The underlying techniques are enabled based on ML models that are trained to address the complexities of this example application and provide real-time guidance using the various techniques disclosed below.

In one aspect, the asset management system 200 includes a real property model that models real property and includes a single latitude and longitude as a base abstraction for the real property model. In this case, the abstraction is a logical representation of the real property (e.g., a struct, a class, a type, etc.) and is not an idea, but rather information that represents a real property within the asset management system 200. In this case, a real property is defined as a separate, non-connected building or other physical structure (e.g., a hangar) on a parcel unless that structure is deemed insignificant (e.g., a shed, a garage, a tent are insignificant), is directly occupied by an entity that occupies another building on that same parcel, or the building is a multi-housing unit (e.g., an apartment complex). A structure is deemed insignificant based on a plurality of different factors, primarily based on how transient the structure is. For example, a shed or a garage can easily be relocated and would be insignificant. A simple metalized enclosure attached to a foundation would be significant.

The real property model also includes a parcel and a building footprint of the real property. The building, parcel, and footprint have a many-to-many relationship at a single geolocation and provide a source a definitive source of truth. The building footprint can represent the metes and bounds of a real property that is occupied by a tenant. In some aspects, resolving addresses and other location data can be non-trivial because there are multiple sources of data, and variations within the other data can create collisions of data, which can have downstream effects such as false positives. In some aspects, the many-to-many relationship enables accurate representation of various interests and enables identification of impacted resources. In one example, a single real property model can be associated with multiple parcels. In another example, the real property model be associated with a single parcel, and the single parcel is associated with multiple real properties.

The asset management system 200 may also be configured to interact with different services to train the ML models and include various services to disambiguate different information. For example, the backend 202 may be configured to interact with third-party services 220 for retrieving structured and unstructured data. For example, the asset management system 200 may receive data services from news services pertaining to business operations, various media sources, and wire services. In another aspect, the third-party services 220 may integrate with third-party APIs to retrieve information in a structured manner, such as an API associated with the Public Access to Court Electronic Records (PACER) to retrieve daily decisions by one or more courts in different jurisdictions. The asset management system 200 may use the data provided by the third-party services 220 to monitor assets in real-time changes to provide intelligence and data that is impracticable using conventional manual (e.g., human) operations and procedural, logic-based techniques.

The asset management system 200 also includes an asset service 222 that is built to represent real property assets. The asset service 222 includes a repository (e.g., a database) and additional set of tools to build a representation of real property assets used in commercial leasehold agreements. For example, the asset service 222 includes various tools to clean data and build a dataset that represents real property assets over time (e.g., a time series database). The asset service 222 allows complex querying, identification of interests, and other relationships that evolve over time. For example, the asset service 222 may store data in a data lake 230 to surface information pertinent to different services. In some cases, the data provided by the asset service 222 can be used by the generative response engine 210 to train ML models and other functions.

The asset management system 200 includes a property entity resolution service 224 that is configured to generate a unique property identifier that is persistent. The unique property identifier cannot be represented by a discrete address because discrete addresses inherently represent an area. Properties are fluid, and using an area to represent unique can introduce downstream effects. For example, the many-to-many relationship and the persistent identifiers can be used to correctly model parcel changes in the event of merging, splitting, and other parcel and real property changes. In some cases, the property entity resolution service 224 includes various tools, services, and ML models to generate the unique property identifier. The property identifiers allow different natural language representations of a physical asset to be resolved into the property identifier. Conventionally, it is impossible to identify match entities between different datasets using only value, such as a mailing address. For example, mail addresses are often used as a proxy identifier, but this is a naïve approach and does not consider that multiple addresses can refer to the same location, errors in the data (e.g., a misspelling) can misidentify assets and provide false data, and so forth. As an example, the Empire State Building has at least three unique addresses (350 5th Ave, 22 W 34th St, and 17 W 33rd St). Further, the addresses of 456 Maple Avenue, Apt 1B, New York, NY 10001 and 456 Maple Street, Apt 1B, New York, NY 10001 are different.

Based on the property identifier, the property entity resolution service 224 is able to map information to addresses and entities with high fidelity. For example, the property identifier can be used for training to ensure that the features are correctly learned to identify latent impacts that are impossible with conventional tools and manual processes because downstream effects are exponentially complex. Latent impacts cannot be conventionally mapped to human processes and require an order of magnitude of inferences that ML models can provide. In addition, property assets are fluid and the property entity resolution service 224 is able to map changes autonomously and update necessary data to maintain a high-quality dataset.

In some aspects, the property entity resolution service 224 is configured to identify a property identifier for each real property asset based on information in different forms. For example, the property entity resolution service 224 can map physical addresses and other information from unstructured sources (e.g., news, press releases, etc.) in natural language from into the property identifier with accuracy. The property entity resolution service 224 can also use numerical information (e.g., vectors) to search for assets based on different parameters (e.g., properties within a radius of a center point, properties with a particular zoning in a radius, etc.) to identify nearby addresses and entities. The property entity resolution service 224 is able to join disparate datasets that have data in different structures and information to prevent misidentification, collisions, duplicates, and other problems that occur with multiple sources of data when identifying real assets. For example, the property entity resolution service 224 enables the structured information from the asset service 222 to be used in conjunction with information from the third-party services 220 in a consistent manner.

The asset management system 200 also includes a tenant resolution service 226 that is able to resolve the tenants within a building to a unique and persistent tenant identifier. The tenant resolution service 226 is structured around a tenant entity resolution model that models relationships between tenants and entities. For example, the tenant resolution service 226 can resolve tenants into an Orbis ID, which uniquely identifies millions of tenants. In some cases, the tenant resolution service 226 may also store detailed financial information such as public records associated with regulatory agencies.

The tenant identifier and financial information available in the asset service 222 may uncover hidden trends and reveal data that is impractical using conventional methods. For example, the asset management system 200, as further described below, and performs asset valuation and identifies asset performance issues based on learned trends (e.g., from the asset service 222). The asset management system 200 can use natural language queries to generate data representing trends, as well as predict potential effects within the market based on normalizing data with the tenant identifier and the property identifier. The tenant identifier represents a legal entity (e.g., a corporation, a university, etc.) and enables an entity resolution service to identify interested parties. In some aspects, the property identifier and the tenant identifier enable the accurate modeling of relationships between assets (e.g., properties) and the entities. For example, the property identifier and the tenant identifier can be used to generate a graph that maps nodes (e.g., property, entities) with edges (e.g., relationships such as property-to-property, entity-to-entity, and property-to-entity). In some aspects, the graph can be represented by a generic of Node<T> representing different models of type T (e.g., an entity, a property, etc.). The different types that can be represented by T correspond to different data structures and can include other assets, such as property interests, agreements (e.g., leases), and so forth. The scope of the graph encompasses all data and forms a monolithic data with insights that can only be extracted using a processor based on the volume of data and complexity of the relationships.

The asset management system 200 also includes an intake service 228 that is configured to capture private asset information and map the private asset information to the data associated with the asset management system 200, such as the property entity resolution service 224 and the tenant resolution service 226. In some aspects, the intake service 228 ingests private data in an unstructured form (e.g., spreadsheets, PDFs, email, handwritten notes, etc.) and normalizes the data into a structured form. For example, the intake service 228 can identify real property assets and retrieve a property identifier associated with the real property asset from the property entity resolution service 224. The intake service 228 may also identify entities, tenants, and other information within the ingested information. The intake service 228 is private data specific to a customer and is stored in a private repository 232 to separate different information.

The engines of the asset management system 200 may be packaged functional hardware units designed for use with other components, a part of a program that performs a particular function (e.g., of related functions), or configured as a container image that is executed in conjunction with a container system such as Kubernetes. The functionality of the asset management system 200 may be split across multiple computing devices (or containers) to allow for distributed processing of the data, which may improve output speed and reduce computational load on individual devices.

In some aspects, the various engines may be executed using a neural engine for on-device execution. A neural engine that includes a plurality of neural processing cores that are configured to parallelize operations associated with neural networks. A neural processing core includes arrays of multiply-accumulate (MAC) units and specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of an ML model) or training of deep learning models and accelerates tasks by parallelization of larger computations that can be performed in parallel (e.g., matrix operations associated with neural networks). For example, a neural engine may perform computer vision tasks such as object recognition. In some cases, the neural engine can be implemented based on various ML libraries such as PyTorch, which interfaces with the compute unified device architecture (CUDA) to parallelize operations.

A non-limiting example of an ML model is a transformer model, which includes a multi-layer encoder-decoder architecture. The encoder takes the input text, converts the input text into a sequence of hidden representations, and captures the meaning of the text at different levels of abstraction. The decoder then uses these representations to generate an output sequence, such as a text translation or a summary. The encoder and decoder are trained together using a combination of supervised and unsupervised learning techniques, such as maximum likelihood estimation and self-supervised pretraining. Illustrative examples of transformer engines include a Bidirectional Encoder Representations from Transformers (BERT) model, a Text-to-Text Transfer Transformer (T5), biomedical BERT (BioBERT), scientific BERT (SciBERT), and the SPECTER model for document-level representation learning. In some aspects, multiple transformer engines may be used to generate different embeddings.

An embedding is a representation of a discrete object, such as a word, a document, or an image, as a continuous vector in a multi-dimensional space. An embedding captures the semantic or structural relationships between the objects, such that similar objects are mapped to nearby vectors, and dissimilar objects are mapped to distant vectors. Embeddings are commonly used in machine learning, computer vision, and natural language processing tasks, such as language modeling, sentiment analysis, and machine translation. Embeddings are typically learned from large corpora of data using unsupervised learning algorithms, such as word2vec, GloVe, or fastText, which optimize the embeddings based on the co-occurrence or context of the objects in the data. Once learned, embeddings can be used to improve the performance of downstream tasks by providing a more meaningful and compact representation of the objects. Embeddings are sometimes referred to as features and represent a learned concept in vector space (e.g., 768 dimensional vectors) that can be understood by the machine in context with other vectors.

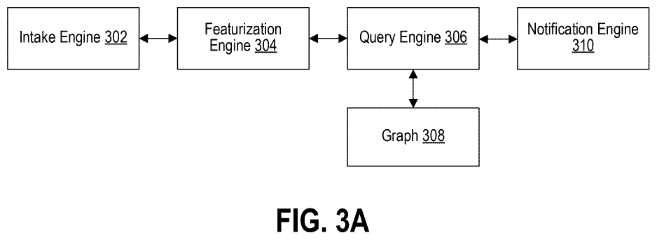

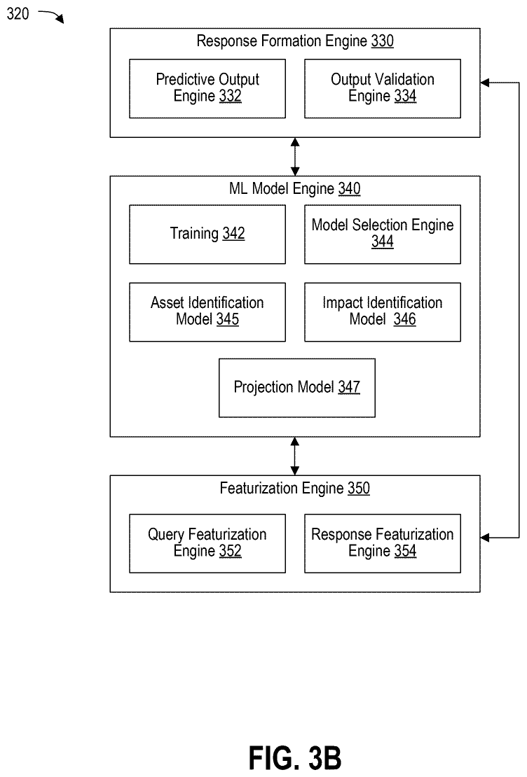

FIG. 3A illustrates a functional block diagram of an asset management system 300 in accordance with some aspects of the disclosure. For example, the asset management system 300 may have an architecture illustrated in FIG. 2. In this example, the asset management system 300 omits ML functionality and the various aspects can be implemented using conventional logical rule-based approach using declarative or imperative techniques.

The asset management system 300 initially receives content (e.g., from the third-party services 220) via an intake engine 302. The intake engine 302 ingests content and may perform various logical functions such as extracting names, matching identifiers, associated with the content. Non-limiting examples of content include news, wire services, business services, and other information that can be pertinent in identifying asset valuation changes. A featurization engine 304 is configured to extract information from the unstructured information. For example, the featurization engine 304 can be configured to identify addresses, specific terms (e.g., bankruptcy, etc.), using conventional procedural techniques. For example, the featurization engine 304 can include a tokenizer that is configured to separate and join words based on various features (e.g., a rule for identifying an address, a named entity recognition (NER) database, etc.

The features extracted from the featurization engine 304 are provided to a query engine 306 for querying related items in a database or other data storage mechanism. A non-limiting example of another data storage mechanism is a graph database. A graph database represents and stores data in the form of nodes (entities, properties, etc.) and edges (relationships) rather than using tables, as in relational databases. A graph database allows for efficient querying of complex, and interconnected data. For example, a graph database can be used to perform complex analysis of networks, hierarchies, or relationships to extract explicit or implicit relationships. In one example, the query engine 306 queries the graph 308 to find a corresponding node or nodes based on the extracted features.

A notification engine 310 is configured to receive the node or nodes from the query engine 306 and generate an output or other notifications. For example, the notification engine 310 can provide data to a dashboard (e.g., by storing the data in a corresponding format for the dashboard), or may send a communication to a person based on a specific event. In one aspect, the query engine 306 identifies an event that can impact an entity based on an address. For example, the query engine 306 identifies that a retailer is closing a store at a property within the same parcel as an interested party. This information can be used by a party to identify insights into events in real time. For example, the retailer closing the store may be beneficial to the party.

The asset management system 300 omits ML aspects and can be driven with pure procedural logic based on the property model and entity model described above.

FIG. 3B illustrates a block diagram of a generative response engine 320 (e.g., the generative response engine 210 in FIG. 2) and includes a response formation engine 330, an ML model engine 340, and a featurization engine 350 in accordance with some aspects of the disclosure. The generative response engine 320 is configured to generate a complex response to complex input in a natural form that is contextually correct.

The response formation engine 330 includes a predictive output engine 332 to analyze the input, identify relevant patterns and associations in the data that the response formation engine 330 has learned, and generate a sequence of words that is a coherent and contextually relevant answer. An output validation engine 334 validates the responses generated by the predictive output engine 332.

The ML model engine 340 includes a training engine 342 configured to train and fine-tune one or more models. For example, the training engine 342 may continually fine-tune train each of the various models within the system, including the models used within the response formation engine 330 or the featurization engine 350. Further examples of fine-tune training are provided below. The ML model engine 340 may also include a model selection engine 344 that is configured to select operation of one or more models. Non-limiting examples of models include an asset management model 345, an impact identification model 346, and a projection model 347.

The asset management model 345 is configured to identify assets that may be impacted based on events that are ingested into the system (e.g., from the third-party services 220 in FIG. 2). For example, asset management model 345 can identify assets of a customer (e.g., from the private repository 232) may be impacted by news events, regulatory decisions, market events, investments (e.g., share pricing, etc.) and so forth that are ingested from different sources. In the case of a news event or a press release, the asset management model 345 may use the property entity resolution service (e.g., the property entity resolution service 224) to identify the property identifier of the asset identified in the news event or press release and then identify assets of a client that could be impacted. For example, a press release identifying the closing of retail locations can affect the real property assets that were identified based on providing unstructured data to the system (e.g., the asset management system 200). The asset management model 345 may be configured to specifically identify features within third-party sources (e.g., news, press releases, zoning decisions, judicial decisions, etc.) and map changes that can affect a particular client.

The impact identification model 346 is configured to identify the impacts of ingested events and latent effects. For example, the impact identification model 346 can predict how market rent rates are affected based on a retailer exiting particular markets. The impact identification model 346 may be trained based on data ingested and stored in a data lake (e.g., from the asset service 222).

The projection model 347 is configured to project changes based on input into the ML model engine 340. For example, a query may be provided to forecast possible changes based on specific events, and the projection model 347 can receive this query and generate a response based on the query. The projection model 347 can receive a natural language query (e.g., human-readable text), which has been processed and normalized in various respects, and may be configured to generate a prediction. The query can include assumptions and constraints and the projection model 347 may generate a response based on the event (e.g., retail store closings) and the various contacts. As an example, a query can ask to forecast a new value of a real property based on an assumption that market rental rates drop after a retailer abandons a lease. The projection model 347 may incorporate other models such as the impact model to generate such a forecast. Additional examples of the projection model 347 are non-limiting examples of queries are identified below. In some cases, the impact identification model 316 and the projection model 347 may be a single model and different paths to perform different functions are invoked based on the query.

The featurization engine 350 may include a query featurization engine 352 and a response featurization model 527. The query featurization engine 352 may be a combination of logic and ML model and is configured to convert features within a text into a machine readable features (e.g., multi-dimensional vectors). For example, the query featurization engine 352 may include an attention mechanism to identify important features of the content to allow other components (e.g., the projection model 347) to perform generic instructions that are in natural language format. The response featurization model 354 is configured to convert features within a response into different forms of responses. For example, the response featurization model 354 can generate graphs, tables, images, and other forms of content.

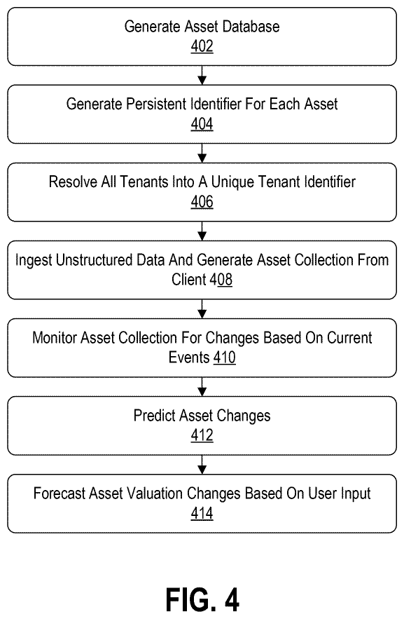

In some aspects, the generative response engine 320 is configured to generate a synthesized output from the different components and provide that output to a client (e.g., the backend 202 or the frontend 204). For example, in some cases, the frontend 204 renders the output into markup (e.g., hypertext markup language) and provides the markup to the backend 202. In other examples, the backend 202 receives data from the frontend 204 and renders the output into markup. FIG. 4 illustrates an example method for real-time analysis of assets using an ML model in accordance with some aspects of the disclosure. Although the example method 400 depicts a particular sequence of operations, the sequence may be altered without departing from the scope of the present disclosure. For example, some of the operations depicted may be performed in parallel or in a different sequence that does not materially affect the function of method 400. Some of the functions may be performed asynchronously, or over a period of time. Although a computing device (e.g., using a processor, a system-on-chip (SoC), etc.) is described as performing the method, this example is for descriptive purposes. The method may be performed in a distributed manner using cloud computing, various containers, microservices, and other techniques.

At block 402, the computing device may generate an asset database or repository. For example, the computing device may employ various tools to enable users to populate information, ingest information available from public sources, or load commercially provided datasets. The asset database may be premised on a physical location, such as a latitude and longitude, and may represent real property on a parcel. For example, the transient assets on real property can be excluded. The asset database or repository can include data from many different locations and are cleaned to provide structure, financial information, and other complex data in a single location.

At block 404, the computing device may generate a unique property identifier for each real property. The unique property is generated for each distinct physical location and represents a structure that can be allocated, divided into footprints, leased, sold, managed, and so forth. In some aspects, the real property may be commercial real estate that is defined as a building, a group of building, or a parcel of land that can be sold. In some cases, the real property may be represented by a color coded dot on a map, and each separate, non-connected building on a parcel. Each separate, non-connected building on a parcel must have its own identifier unless the structure is insignificant (e.g., a shed, a garage), the building is directly occupied by a business that occupies another building on the parcel, or the building in a multifamily dwelling (e.g., an apartment complex) with multiple related buildings.

At block 406, the computing device may resolve tenants into a unique tenant identifier. The tenant identifier represents a physical footprint occupied by an entity and can change over time. For example, the tenant identifier may be an Orbis identifier or a Bureau van Dijk (BVD) identifier. An Orbis identifier is used to uniquely reference companies in Orbis's repository, which includes information on financials, ownership structures, and credit scores. Orbis identifiers facilitate precise identification and tracking of organizations across different regions and data sources and enable identification of asset valuation changes in connection with the unique property identifier.

For example, the physical footprint can change (e.g., the footprint merges with another footprint), or lease change can affect the entity. In some cases, the footprint can be sublet to others, creating a complex chain of interests. The tenant identifier directly links the upstream entity with the footprint.

At block 408, the computing device may ingest unstructured data and generate an asset collection data from a client. For example, unstructured data can include PDFs, spreadsheets, documents, handwritten notes, contracts, and so forth. During block 408, the computing device can generate structured information and identify relevant information associated with the ingested data. For example, during block 408, the computing system may use the property entity resolution service to retrieve the unique property identifier of the property identified in various documents and spreadsheets.

At block 410, the computing device may monitor asset collections (of clients) for changes based on current events. For example, news events, regulatory decisions, market events, investments (e.g., share pricing, etc.), and other sources of financial-oriented data are ingested by the computing device. Data associated with these events are extracted and monitored to identify any event that would have a downstream effect on the valuation of assets within the asset collections. Some events may be direct (e.g., a tenant filing for bankruptcy protection) and other events may be indirect (e.g., closing retail locations in different markets).

At block 412, the computing device may predict asset changes based on the nexus of the events identified in block 410. For example, the computing device may forecast a simple change to market rental rates based on vacancy. At this stage, the computing device may use the prediction to determine the importance of the notification based on a cursory analysis (e.g., high priority, low priority). The prediction can be holistic and evaluate the range of assets of a client and provide assurance that an appropriate amount of risk is being taken based on client parameters. For example, customers may want to be risk averse for periods of time (e.g., during an acquisition) and may want to limit exposure to market fluctuations. In some aspects, notifications for a client are generated based on the predicted asset changes at block 412.

At block 414, the computing device may forecast asset valuation changes based on user input. For example, the computing device may receive a natural language input (e.g., text, voice, etc.) with at least one request to forecast valuation changes of real property assets. The request can include at least one constraint or assumption to control the prediction. For example, a user can request a new net operating income (NOI) based on a modified rental rate when a large tenant abandons a leasehold. In this example, the user can also request specific information to display, such as debt service coverage ratio (DSCR) and loan-to-value (LTV) rates. In this case, the computing device may access a resource for the current information (e.g., the asset service 222 in FIG. 2) pertaining to relevant financial information. The computing device can retrieve relevant information based on the request, and recompute the necessary data nearly instantaneously.

In some aspects, an ML model can be employed at block 414 can perform many different tasks within milliseconds and provide relevant information. The ML model is trained to identify and retrieve external data from a normalized source, synthesize information based on natural language input, and provide results based on the request. Conventional techniques to perform similar processes take weeks to propagate the event, merge that event into systems, and then surface the changes of that event to the client.

While ML models could be employed to individually perform some of these functions, technology to vertically stack each of these functions has been unavailable. Vertical integration exposes a technology stack to failure, and for this reason procedural logic could not be employed to predict asset valuation. Procedural logic would fail at many different aspects, such as the identification of property identifiers. Further, data synthesis and data validation remains the most challenging process because machines are not easily able to distinguish between features, errors, and flaws that a person can. The disclosed property identifiers and the mappings of the property identifiers enable the computing system to join very different data sources and accurately map information between the data sources to achieve a higher degree of integration. The property identifiers also enable the training of the ML model and ensure that the ML model does not misidentify distinct properties.

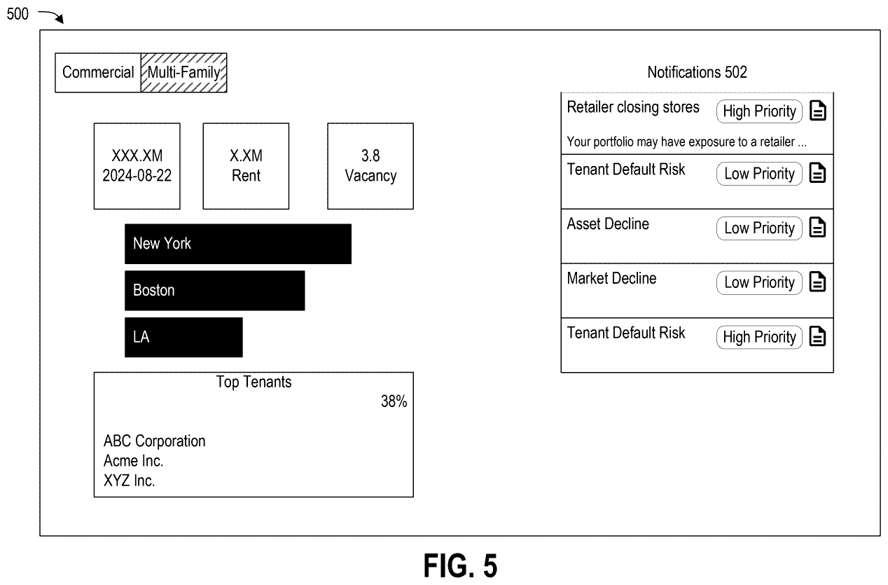

FIG. 5 illustrates example notifications of a real-time asset management system in accordance with some aspects of the disclosure. In particular, a screenshot 500 of the real-time asset management system shows a dashboard with notifications 502. In this example, a client has uploaded data into the asset management system regarding assets for the asset management system to monitor for nearby and downstream events. In this case, the notifications 502 includes some broader evaluations, such as normal fluctuations in the market. The notifications 502 also includes more specific valuation events, such as the potential abandonment of leasehold agreements. In some aspects, the asset management system also monitors risk tolerance associated with tenants. For example, the asset management system may be aware of a specific tenant (e.g., based on ingesting and normalizing data via the intake service 228 in FIG. 2) and may detect the tenant's risk of default has increased. This can be important to assist commercial real estate companies in identifying and minimizing unnecessary risks.

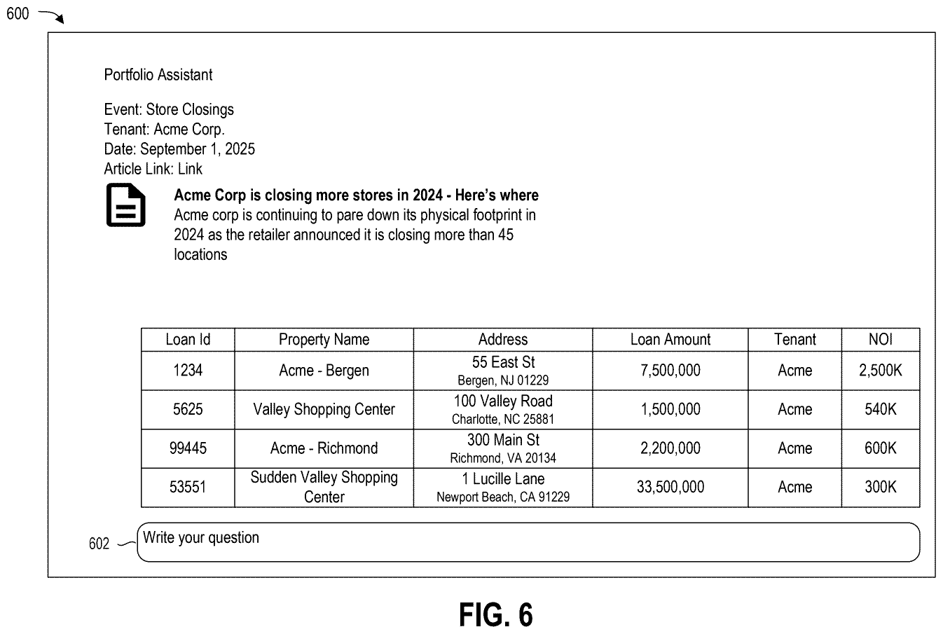

FIG. 6 illustrates an example identification of valuation changes of a client's assets in accordance with some aspects of the disclosure. In particular, a screenshot 600 shows a notification of the real-time asset management system and identification of assets that may be put at risk of devaluation based on current events that are ingested into the asset management system. FIG. 6 illustrates a context of an ML model that can be interacted with. For example, a text input field 602 can receive natural language input requesting forecasting of changes to one or more items in the table in the screenshot 600, or other data.

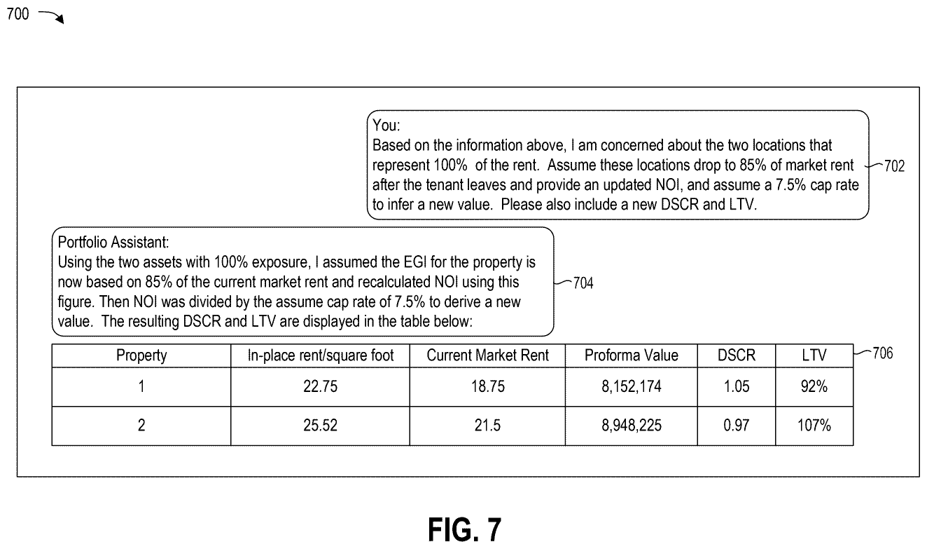

FIG. 7 illustrates an example prediction of valuation changes based on user input in accordance with some aspects of the disclosure. In particular, a screenshot 700 shows a user input 702 is provided to the ML model requesting forecasted changes based a constraint (e.g., market rent changes, cap rate) and at least one output parameter (e.g., NOI, DSCR). The ML model provides a generated response 704 that is contextually relevant to the user input 702 and a table 706 that includes the requested data. In this case, a client is able to quickly predict potential changes in valuations and can respond before other actors in the market.

The asset management system synthesizes learned financial, asset, and other relevant market information based on data that underlies the system and is able to sequence together information stored in the system with human-level commands. Clients can perceive changes in the market and react first, providing a competitive advantage based on joining different data sources using a unique property identifier. For example, in the screenshot 700, the LTV of the second listing is higher and is potentially more at risk. A client can use this information to minimize exposure to risk.

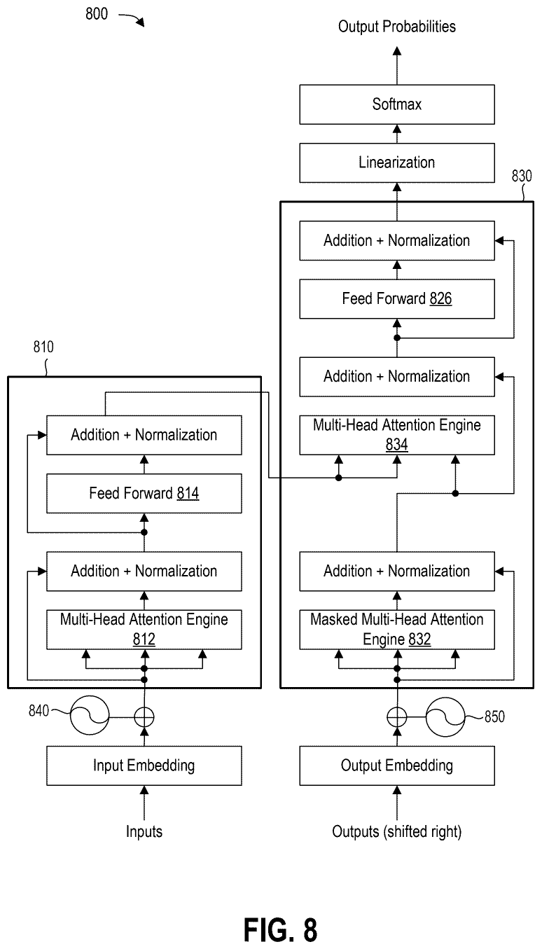

FIG. 8 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. Transformer 800 reduces the operations of learning dependencies by using encoder 810 and decoder 830 that implements an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, encoder 810 is composed of a stack of six identical layers and each layer has two sub-layers. The first sub-layer is multi-head self-attention engine 812, and the second sub-layer is a fully connected feed-forward network 814. A residual connection (not shown) connects around each of the sub-layers followed by normalization.

In this example of transformer 800, decoder 830 is also composed of a stack of six 6 identical layers. The decoder also includes masked multi-head self-attention engine 832, multi-head attention engine 834 over the output of encoder 810, and fully connected feed-forward network 826. Each layer includes a residual connection (not shown) around the layer, which is followed by layer normalization. Masked multi-head self-attention engine 832 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes positional encoder 840 to encode positions because the model does not contain recurrence and convolution and relative or absolute position of the tokens is needed. In transformer 800, the positional encodings are added to the input embeddings at the bottom layer of encoder 810 and decoder 830. The positional encodings are summed with the embeddings because the positional encodings and embeddings have the same dimensions. A corresponding position decoder 850 is configured to decode the positions of the embeddings for decoder 830.

In some aspects, transformer 800 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. Transformer 800 can process input sequences of variable length, making it well-suited for natural language processing tasks where input lengths can vary greatly. Additionally, the self-attention mechanism allows transformer 800 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

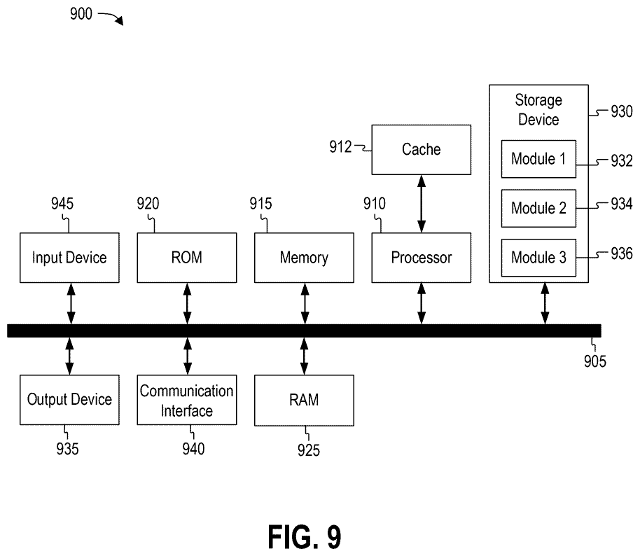

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 900 includes at least one processing unit (a central processing unit (CPU) or processor) 910 and connection 905 that couples various system components including system memory 915, such as ROM 920 and RAM 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., method 400, and/or other process described herein) may be performed by a computing device or apparatus. In one example, the method 400 can be performed by a computing device having a computing architecture of the computing system 900 shown in FIG. 9.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™M standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, graphical processing units (GPUs), digital signal processors (DSPs), CPUs, and/or other suitable electronic circuits), and/or can include and/or be implemented using computer software, firmware, or any combination thereof, to perform the various operations described herein.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

In some aspects, the various engines may be executed using a neural engine for on-device execution. A neural engine that includes a plurality of neural processing cores that are configured to parallelize operations associated with neural networks. A neural processing core includes arrays of multiply-accumulate (MAC) units and specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of an ML model) or training of deep learning models and accelerates tasks by parallelization of larger computations that can be performed in parallel (e.g., matrix operations associated with neural networks). For example, a neural engine may perform computer vision tasks such as object recognition. In some cases, the neural engine can be implemented based on various ML libraries such as PyTorch, which interfaces with the compute unified device architecture (CUDA) to parallelize operations.

A non-limiting example of an ML model is a transformer model, which includes a multi-layer encoder-decoder architecture. The encoder takes the input text, converts the input text into a sequence of hidden representations, and captures the meaning of the text at different levels of abstraction. The decoder then uses these representations to generate an output sequence, such as a text translation or a summary. The encoder and decoder are trained together using a combination of supervised and unsupervised learning techniques, such as maximum likelihood estimation and self-supervised pretraining. Illustrative examples of transformer engines include a Bidirectional Encoder Representations from Transformers (BERT) model, a Text-to-Text Transfer Transformer (T5), biomedical BERT (BioBERT), scientific BERT (SciBERT), and the SPECTER model for document-level representation learning. In some aspects, multiple transformer engines may be used to generate different embeddings.

An embedding is a representation of a discrete object, such as a word, a document, or an image, as a continuous vector in a multi-dimensional space. An embedding captures the semantic or structural relationships between the objects, such that similar objects are mapped to nearby vectors, and dissimilar objects are mapped to distant vectors. Embeddings are commonly used in machine learning, computer vision, and natural language processing tasks, such as language modeling, sentiment analysis, and machine translation. Embeddings are typically learned from large corpora of data using unsupervised learning algorithms, such as word2vec, GloVe, or fastText, which optimize the embeddings based on the co-occurrence or context of the objects in the data. Once learned, embeddings can be used to improve the performance of downstream tasks by providing a more meaningful and compact representation of the objects. Embeddings are sometimes referred to as features and represent a learned concept in vector space (e.g., 768 dimensional vectors) that can be understood by the machine in context with other vectors.

One of ordinary skill will appreciate that the less than (<) and greater than (>) symbols or terminology used herein may be replaced with less than or equal to (“S”) and greater than or equal to (“>”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The claim language relates to functions performed by a processor device and a person of skill in the art would recognize that the functions described herein and below are intended to operate at a scale not practical for a person. A person of skill in the art would recognize that the claims as defined below cannot be performed in the human mind and improve the operations of a processor within at least commercial real estate applications.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

1. A method for unstructured asset convergence, monitoring, and forecasting, comprising:
receiving a collection of unstructured data;
generating structured data based on the collection of unstructured data;
generating a first property identifier of a first asset within the structured data using a machine learning model, the first property identifier being associated with a single physical structure;
in response to receiving an unstructured notification of an event, identifying an entity associated with the event and a second asset corresponding to the entity;
generating a second property identifier of the second asset and an entity identifier for the entity;
modeling, using the machine learning model, many-to-many relationships between the first asset and both the second asset and the entity as a graph of nodes based on the first property identifier, the second property identifier, and the entity identifier;
determining an impact of the event on the first asset based on at least one of a proximity of the first asset to the second asset within the graph or a proximity of the first asset to the entity within the graph; and
predicting a valuation change to the first asset based on the impact.

2. The method of claim 1, further comprising:
in response to receiving a query associated with the event, obtaining a response related to the query.

3. The method of claim 2, wherein the response includes a notification of the predicted valuation change to the first asset.

4. The method of claim 2, wherein the query includes at least one constraint regarding the prediction and at least one type of output information to generate.

5. The method of claim 1, wherein the machine learning model is trained on a dataset including a plurality of persistent property identifiers and a plurality of persistent tenant identifiers that uniquely identify real property assets and legal entities, wherein a respective property identifier is decoupled from a physical location.

6. The method of claim 1, further comprising:
employing a search vector across the many-to-many relationships of the graph to identify the second asset relational to the first asset.

7. The method of claim 1, wherein determining the impact of the event on the first asset comprises:
identifying assets associated with the entity based on a direct relationship with the entity within the graph.

8. The method of claim 1, further comprising:
determining a latent impact of the event on the first asset by locating the second asset within the graph and identifying, using the machine learning model, assets to be impacted associated with the entity based on an inferred relationship.

9. The method of claim 1, wherein the predicted valuation change to the first asset comprises an estimated valuation change or an estimated cost.

10. The method of claim 1, further comprising:
retrieving asset data associated with a plurality of assets and entity data associated with a plurality of entities;
generating a unique persistent property identifier for each asset of the plurality of assets and a unique persistent entity identifier for each entity of the plurality of entities, wherein the property identifiers and entity identifiers are uncoupled from a physical location;
modeling a plurality of many-to-many relationships between the plurality of assets and the plurality of entities by mapping the property identifiers and entity identifiers as nodes within the graph.

11. A computing device for unstructured asset convergence, monitoring, and forecasting, comprising:
at least one memory; and
at least one processor coupled to the at least one memory and configured to:
receive a collection of unstructured data;
generate structured data based on the collection of unstructured data;
generate a first property identifier of a first asset within the structured data using a machine learning model, the first property identifier being associated with a single physical structure;
in response to receiving an unstructured notification of an event, identify an entity associated with the event and a second asset corresponding to the entity;
generate a second property identifier of the second asset and an entity identifier for the entity;
model using the machine learning model, many-to-many relationships between the first asset and both the second asset and the entity as a graph of nodes based on the first property identifier, the second property identifier, and the entity identifier;
determine an impact of the event on the first asset based on at least one of a proximity of the first asset to the second asset within the graph or a proximity of the first asset to the entity within the graph; and
predicting a valuation change to the first asset based on the impact.

12. The computing device of claim 11, wherein the at least one processor is configured to:
in response to receiving a query associated with the event, obtain a response related to the query.

13. The computing device of claim 12, wherein the response includes a notification of the predicted valuation change to the first asset.

14. The computing device of claim 12, wherein the query includes at least one constraint regarding the prediction and at least one type of output information to generate.

15. The computing device of claim 11, wherein the machine learning model is trained on a dataset including a plurality of persistent property identifiers and a plurality of persistent tenant identifiers that uniquely identify real property assets and legal entities, wherein a respective property identifier is decoupled from a physical location.

16. The computing device of claim 11, wherein the at least one processor is configured to:
employ a search vector across the many-to-many relationships of the graph to identify the second asset relational to the first asset.

17. The computing device of claim 11, wherein the at least one processor is configured to:
identify assets associated with the entity based on a direct relationship with the entity within the graph.

18. The computing device of claim 11, wherein the at least one processor is configured to:
determine a latent impact of the event on the first asset by locating the second asset within the graph and identifying, using the machine learning model, assets to be impacted associated with the entity based on an inferred relationship.

19. The computing device of claim 11, The method of wherein the predicted valuation change to the first asset comprises an estimated valuation change or an estimated cost.

20. The computing device of claim 11, wherein the at least one processor is configured to:
retrieve asset data associated with a plurality of assets and entity data associated with a plurality of entities;
generate a unique persistent property identifier for each asset of the plurality of assets and a unique persistent entity identifier for each entity of the plurality of entities, wherein the property identifiers and entity identifiers are uncoupled from a physical location; and
model a plurality of many-to-many relationships between the plurality of assets and the plurality of entities by mapping the property identifiers and entity identifiers as nodes within the graph.
